(19) United States
(12) Patent Application Publication
(10) Pub. No.: US 2012/0145579 A1
(43) Pub. Date: Jun. 14, 2012

(54) LABEL, METHODS OF APPLYING AND USING A LABEL, AND A DRUG DELIVERY SYSTEM USING A DOSAGE LABEL

(76) Inventor: THOMAS J. SILVANO, Franklin Lakes, NJ (US)

(21) Appl. No.: 13/110,135

(22) Filed: May 18, 2011

Related U.S. Application Data
(60) Provisional application No. 61/422,837, filed on Dec. 14, 2010.

(51) Int. Cl. B65D 90/00; B42D 15/00; B32B 37/12

(52) U.S. Cl. 206/459.5; 156/60; 283/81

(57) ABSTRACT

A label for a container is provided that includes a bottom layer. The bottom layer backside includes an adhesive adapted to attach the bottom layer to the container, and the bottom layer frontside includes at least two separate printed information sets. Each printed information set is applicable to a respective distinct user group. The label also includes a top layer that is attached to the frontside of the bottom layer. The top layer includes window cut-outs that include a flap rotatable around an attached edge to expose the bottom layer frontside beneath the flap. Each flap is aligned with the corresponding printed information on the bottom layer frontside. Each window cut-out includes on the frontside printed information identifying the distinct user group corresponding to the printed information beneath the respective window cut-out. A container including a label is provided, and methods of attaching a label to a container are provided.

### CROSS-REFERENCE TO RELATED APPLICATIONS

This application claims the benefit of U.S. Provisional Application No. 61/422,837 filed Dec. 14, 2010, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to labels for containers, and in particular relates to a dosage label for a pill bottle.

2. Description of Prior Art

Medicine bottles have increasing amounts of information included on them. Children's medicines often have varying dosages depending on the age and/or weight of a child. The different dosages for children may be listed on a chart on the side of the bottle. The information may be dense and therefore printed in a small type, and therefore may be difficult to use. Parents dealing with sick children often may be stressed and likely to make mistakes in reading a label. Too much or too little medicine for a child may have potentially severe adverse consequences for the health of the child.

Some pharmaceutical companies use special bottles and/or multiple labels. Some pharmaceutical companies use flaps on labels to include additional information, and/or to display dosage information. Medicine bottles use restickable layers that may be peeled back to reveal important information.

### BRIEF SUMMARY OF THE INVENTION

The present innovation discloses a dosage label that is easy to use and likely to reduce mistakes in determinations of dosage. The present invention also is easy to apply to a bottle, and does not require any special equipment or bottles.

The present invention provides a solution to dosage labels for children's medicine by providing windows in an outer layer that open to reveal only the specific dosages corresponding to the information printed on the outside of the window. In this manner, the potentially frazzled parent is not even exposed to the incorrect dosages for adjacent ages or weights, and is therefore not likely to make a mistake as to the dosage to be applied.

The dosage label provides an easier reading of dosage by directing the consumer only to the dosage amounts relevant to their needs. This minimizes the possibility of misreading the dosage, and consequently avoids or reduces the risk of underdosing or overdosing a child or other consumer.

A label for a container is provided that includes a bottom layer having a backside and a frontside. The bottom layer backside includes an adhesive adapted to attach the bottom layer to the container, and the bottom layer frontside includes at least two separate printed information sets. Each printed information set is applicable to a respective distinct user group. The label also includes a top layer having a backside and a frontside. The top layer is attached to the frontside of the bottom layer. The top layer includes at least two window cut-outs, each window cut-out including a flap and an attached edge. Each flap is rotatable around the attached edge to expose the bottom layer frontside beneath the flap, and each flap is aligned with the corresponding printed information set on the bottom layer frontside. Each window cut-out includes on the frontside printed information identifying the distinct user group corresponding to the printed information set appearing on the bottom layer frontside beneath the respective window cut-out.

The top layer may be attached to the bottom layer by a further adhesive arranged either 1) on the backside of the top layer in an area separate from the window cut-outs, or 2) on the frontside of the bottom layer in an area separate from the information sets corresponding to the window cut-outs. The top layer and the bottom layer may include a single sheet wrapped around the container more than one time. The top layer and the bottom layer may include two sheets, in which the top layer is applied on top of the bottom layer.

Each window cut-out may include on the backside a releasable adhesive adapted to releasably attach each window cut-out to the bottom layer.

The distinct user groups may be identified by age and/or weight. The separate information sets may include dosages.

The frontside printed information identifying the distinct user group may include information identifying two or more distinct user groups. Two or more information sets may appear on the bottom layer frontside beneath the respective window cut-out, the two or more information sets being presented separately with printed information identifying the respective distinct user group. The frontside printed information identifying the two or more distinct user groups may include a printed range encompassing the two or more distinct user groups.

Each window cut-out may be substantially rectangular, and the window cut-out may be openable by peeling the window cut-out away from the bottom layer starting on an edge opposite the attached edge.

A container including a label is provided.

A method of attaching a label to a container is provided including the operation of applying a bottom layer of the label to the container. The bottom layer has a backside and a frontside. The bottom layer backside includes an adhesive adapted to attach the bottom layer to the container, and the bottom layer frontside includes at least two separate printed information sets. Each printed information set is applicable to a respective distinct user group. The method further includes applying a top layer of the label to the container. The top layer has a backside and a frontside and is attached to the frontside of the bottom layer. The top layer includes at least two window cut-outs, with each window cut-out including a flap and an attached edge. Each flap is rotatable around the attached edge to expose the bottom layer frontside beneath the flap, and each flap is aligned with a corresponding printed information set on the bottom layer frontside. Each window cut-out includes on the frontside printed information identifying the distinct user group corresponding to the printed information set appearing on the bottom layer frontside beneath the respective window cut-out.

In the method, the top layer may be attached to the bottom layer by a further adhesive arranged either 1) on the backside of the top layer in an area separate from the window cut-outs, or 2) on the frontside of the bottom layer in an area separate from the information sets corresponding to the window cut-outs.

Another method of attaching a label to a container is provided that includes applying a first part of the label to the container and applying a second part of the label to the container. The first and second parts of the layer are formed from a single sheet in which the second part of the label is wrapped around the container continuously after applying the first part of the label.

These objects and the detail of this invention will be apparent from the following description and accompanying drawings.

### BRIEF DESCRIPTION OF THE DRAWINGS

FIG. 1a is a front view of a first part of an exemplary label according to the present invention;

FIG. 1b is a back view of the first part of the exemplary label shown in FIG. 1a;

FIG. 1c is a front view of a second part of the exemplary label according to the present invention;

FIG. 1d is a perspective view of a combination of the first and second parts of the exemplary label shown in FIGS. 1a and 1c;

FIG. 2 is a front view of another exemplary label according to the present invention; and

FIG. 3 is a flow chart illustrating an exemplary method according to the present invention.

### DETAILED DESCRIPTION OF THE INVENTION

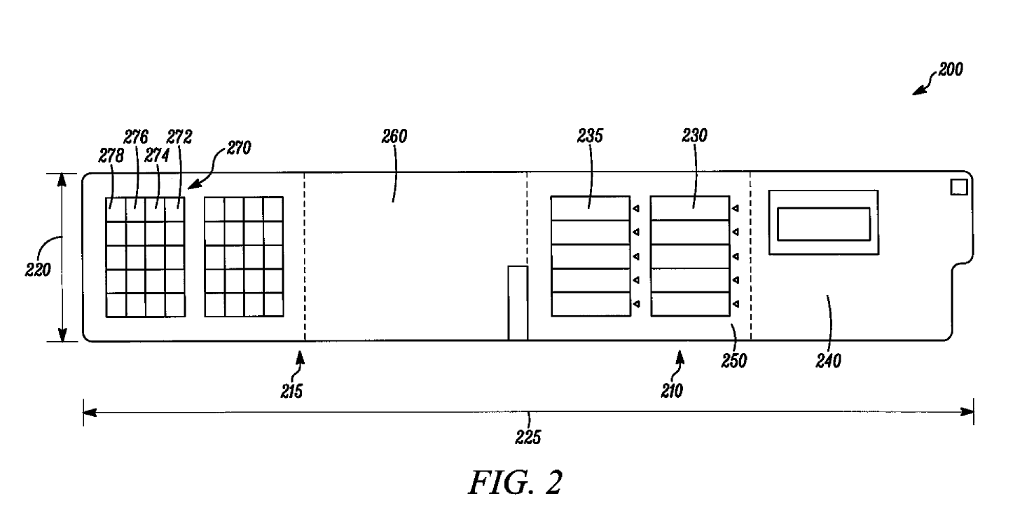

The labels for the invention may wrap around the bottle once (see Figures la through ld, also referred to collectively as the 355 degree figure), or twice (see FIG. 2, also referred to as the 720 degree figure). In both cases, the label is applied in one process step without the requirement for a second label. One of the innovative aspects of the design is that only a single label is applied to the bottle.

The labels include precut windows in the outer layer, with the backs of the windows and/or the outside of the inner label beneath the windows including a releasable coating that enables the window to stay closed but be easily opened and reclosed when the information obstructed by the window is needed. The windows are resealable using a light adhesive or a release coating.

The design provides a way to accurately communicate dosage information to consumers, while maintaining production efficiency for the manufacturer.

The invention accomplishes this in a manner that maintains production efficiencies because, first, it is a single application of a single label. This allows the manufacturer to maintain line speeds in an assembly line producing the medicines, containers and labels. Second, the invention does not require the application of a second overlay as other alternatives do. Third, the invention does not require a special or custom bottle. The invention can be applied to any bottle that is currently being labeled. Fourth, the invention is less expensive because of its design in comparison to other alternatives.

In one exemplary embodiment, the outside of the outer layer over the windows shows a range of weights that are similar. Under the window are several different dosages corresponding to specific weights within the range, or alternatively to specific sub-ranges within the range. In other alternatives, the outside of the outer window includes an age or age range. In still other alternatives, only one dosage is indicated under the window, and the age, age range, weight, or weight range on the outside of the window corresponds to a single group having a single corresponding dosage.

In still other alternatives, the information under the window may correspond to any other appropriate information that reduces the risk of error to a user by obscuring corresponding information that is not important. For instance, if a drug has several different purposes, then different dosages for the different purposes, different prescription limitations, or different potential side-effects based on different dosages, may be under the window.

The labels are cut when printed to provide the appropriate windows. The labels may also include normal adhesives and releasable coatings on various surfaces initially in order to allow the label to be applied in one step and have all of the necessary coatings in place.

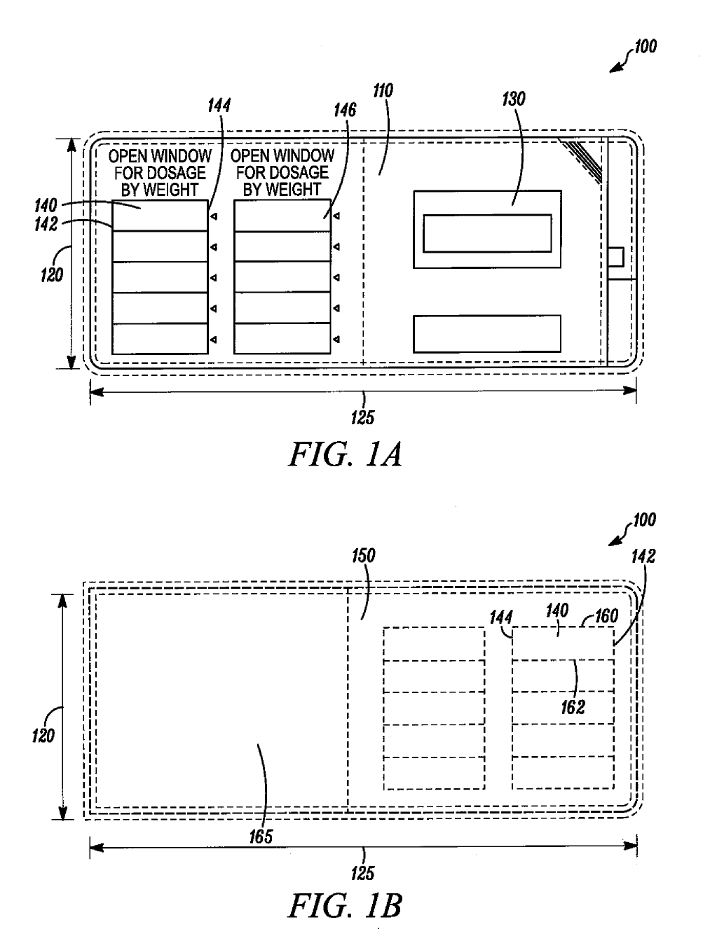

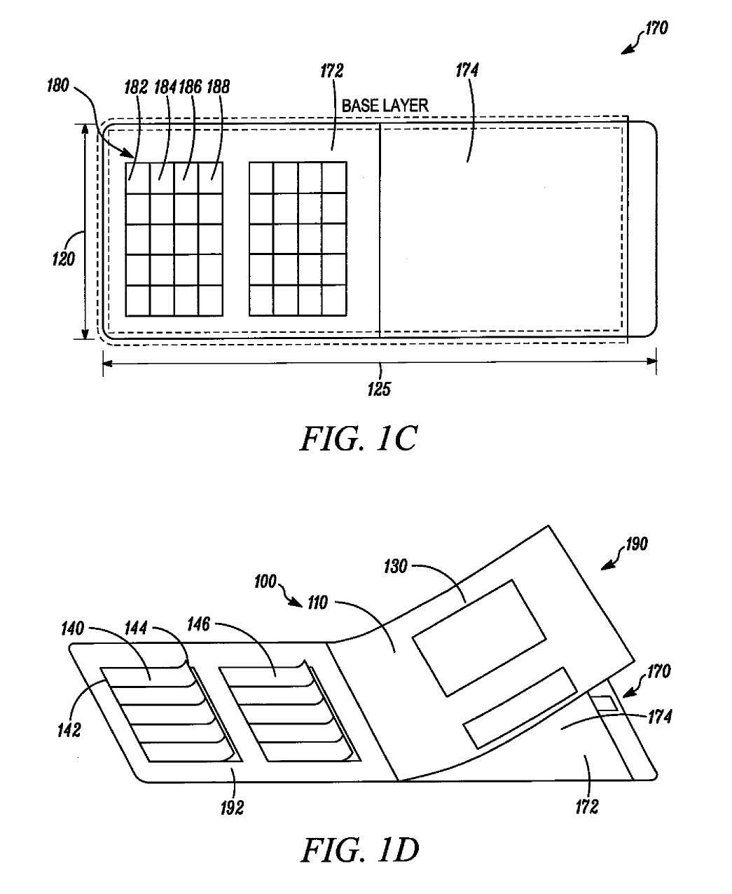

FIG. 1a illustrates a front view of top part 100 of an exemplary label. Top part 100 may have height 120 corresponding to a distance equal to or shorter than the height of the flat surface of a container to which the exemplary label is to be applied. Top part 100 may have width 125 corresponding to a distance equal to or shorter than a diameter of the flat surface of a container to which the exemplary label is to be applied.

Top part 100 includes front surface 110 that includes information 130 to be read by a user. Some of the information on front surface 110 may be presented on windows including for instance window 140. Window 140 may be rectangular and cut out from top part 100 on three of the four edges, and remain connected to top part 100 by connected edge 142. Window 140 may be opened by pulling on edge 144 which is opposite of connected edge 142 and peeling open window 140. Window 140 may have a resealable adhesive on a back side to promote the releasable attachment of window 140 to a bottom layer or a container.

Printed information 146 appearing on a window may identify one or more distinct patient or user groups. The dosage information for the one or more distinct patient groups identified by a window may be covered by the window until the window is opened by a user.

FIG. 1b illustrates a back view of top part 100 of the exemplary label shown in FIG. 1a. Top part 100 may have height 120 corresponding to a distance equal to or shorter than the height of the flat surface of a container to which exemplary label 100 is to be applied. Top part 100 may have width 125 corresponding to a distance equal to or shorter than a diameter of the flat surface of a container to which the exemplary label is to be applied.

Top part 100 includes back surface 150 that includes information 165 to be read by a user when the portion of top part 100 is peeled back or off of the container or lower label to enable a user to read the back of top part 100. Back surface 150 having information 165 may be covered in a resealable adhesive or alternatively a border of a resealable adhesive may surround information 165. In an area of back surface 150 of top part 100 away from information 165 may be the back surface of windows, including window 140. Window 140 may be rectangular and cut out from top part 100 on three of the four edges, including edges 144, 160 and 162. Window 140 may remain connected to top part 100 by connected edge 142. Window 140 may have a resealable adhesive on back surface 150 to promote the releasable attachment of window 140 to a bottom layer or a container.

FIG. 1c is a front view of bottom part 170 of the exemplary label. Bottom part 170 may have height 120 corresponding to a distance equal to or shorter than the height of the flat surface of a container to which the exemplary label is to be applied. Top part 100 may have width 125 corresponding to a distance equal to or shorter than a diameter of the flat surface of a container to which the exemplary label is to be applied.

Bottom part 170 includes front surface 172 that includes printed information 174 to be read by a user. Some of the information on front surface 172 may be arranged to correspond to an exposed area when top part 100 is peeled back, for instance to expose information 165 on back surface 150 of top part 100.

Bottom part 170 also includes on front surface 172 dosage information 180. Dosage information 180 is positioned to align with the windows of top part 100. In particular, when a window is peeled back, dosage information is revealed that corresponds to the one or more distinct patient or user groups identified in the printed information appearing on the front surface of the closed window. In FIG. 1C, the printed information on the front surface of the window identifies a range, and dosage information 180 is divided into sub-groups within the range. For instance, underneath window 140 are distinct patient subgroups 182, 184, 186, and 188. Likewise, each of the other windows includes distinct patient subgroups corresponding to the range of users identified on the front of the window. Alternatively, each window may be peeled back to reveal only one corresponding patient group and therefore only particular dosage information for that one user group.

FIG. 1d is a perspective view of exemplary label 190 including top part 100 and bottom part 170. Top part 100 includes front surface 110 that includes information 130 to be read by a user. Some of the information on front surface 110 may be presented on windows including for instance window 140. Window 140 may be rectangular and cut out from top part 100 on three of the four edges, and remain connected to top part 100 by connected edge 142. Window 140 may be opened by pulling on edge 144 which is opposite of connected edge 142 and peeling open window 140. Window 140 may have a resealable adhesive on a back side to promote the releasable attachment of window 140 to a bottom layer or a container.

Printed information 146 appearing on a window may identify one or more distinct patient or user groups. The dosage information for the one or more distinct patient groups identified by a window may be covered by the window until the window is opened by a user.

Bottom part 170 includes front surface 172 that includes printed information 174 to be read by a user. Some of the information on front surface 172 of bottom part 170 may be arranged to correspond to an exposed area when top part 100 is peeled back.

Top part 100 may be attached to bottom part 170 by non-releasable adhesive applied to a back surface of top part 100, or a top surface of bottom part 170, in area 192 that does not include any printed information.

FIG. 2 is a front view of second exemplary label 200 according to the present invention. Second exemplary label 200 is a single sheet designed to wrap around a container and/or pill bottle twice. Second exemplary label 200 may have height 220 corresponding to a distance equal to or shorter than the height of the flat surface of a container to which the exemplary label is to be applied. Second exemplary label 200 may have width 225 corresponding to a distance equal to or shorter than two times a diameter of the flat surface of a container to which the exemplary label is to be applied.

Bottom part 215 of second exemplary label 200 is applied first to the container, and then second exemplary label 200 is continued to be wrapped around the container so that top part 210 is applied on top of bottom part 215. A back surface of bottom part 215 may have a permanent, or non-releasable adhesive, and portions of the back surface of top part 210, or alternatively portions of the front surface of bottom part 215, may also have a permanent or non-releasable adhesive applied before application of the label to a container. The areas of the back surface of top part 210, or alternatively the areas of the front surface of bottom part 215, which do not have a permanent, or non-releasable, adhesive applied may have a releasable adhesive applied to enable portions of the top part 210, including windows 230 and 235, to be peeled back to reveal information 260 and dosage information 270 on the front surface of bottom part 215.

Top part 210 may include printed information 240, as well as windows 230 and 235. Windows 230 and 235 may operate in the same manner as window 140 discussed in regard to FIGS. 1a, 1b, 1c and 1d. Beneath windows 230 and 235 may be arranged dosage information 270 on a front surface of bottom part 215. Dosage information 270 may be arranged in sub-groups 272, 274, 276 and 278 which sub-divide the range shown on the front surface of window 235, in the same manner as shown in FIG. 1c. Alternatively, dosage information for only one group may be arranged under each window in top part 210.

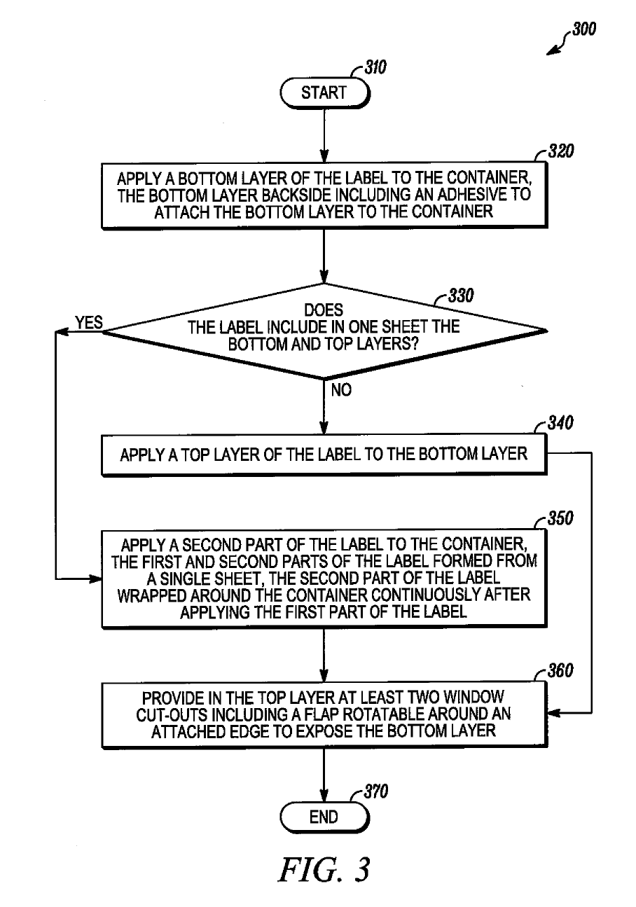

FIG. 3 illustrates method 300 according to an exemplary embodiment. Method 300 starts at start circle 310 and proceeds to operation 320, which indicates to apply a bottom layer of the label to the container. The bottom layer backside includes an adhesive to attach the bottom layer to the container. From operation 320, the flow in method 300 proceeds to decision 330, which asks whether the label includes in one sheet the bottom and top layer. If the answer to decision 330 is negative, the flow in method 300 proceeds to operation 340, which indicates to apply a top layer of the label to the bottom layer. From operation 340 the flow in method 300 proceeds to operation 360, which indicates to provide in the top layer at least two window cut-outs including a flap rotatable around an attached edge to expose the bottom layer. If the answer to decision 330 is affirmative, the flow in method 300 proceeds to operation 350, which indicates to apply a second part of the label to the container. The first and second parts of the label are formed from a single sheet, and the second part of the label is wrapped around the container continuously after applying the first part of the label. From operation 350 the flow in method 300 proceeds to operation 360. From operation 360 the flow in method 300 proceeds to end circle 370.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A label for a container, comprising:
a bottom layer having a first surface and a second surface opposite the first surface, the first surface of the bottom layer including an adhesive adapted to attach the bottom layer to the container, the second surface of the bottom layer including at least two separate printed information sets, each printed information set being applicable to a respective distinct user group; and
a top layer having a first surface and a second surface opposite the first surface, the top layer being attached to the bottom layer, the top layer including at least two window cut-outs, each window cut-out including a flap and an attached edge, each flap being pivotal about the attached edge to expose the second surface of the bottom layer beneath the flap, each flap aligned with the corresponding printed information set on the second surface of the bottom layer, each window cut-out including on the second surface further printed information identifying the distinct user group corresponding to the printed information set appearing on the second surface of the bottom layer beneath the respective window cut-out.

2. The label of claim 1, wherein the top layer is attached to the bottom layer by a further adhesive arranged one of:
on the first surface of the top layer in an area separate from the window cut-outs; and
on the second surface of the bottom layer in an area separate from the information sets corresponding to the window cut-outs.

3. The label of claim 2, wherein the top layer and the bottom layer comprise a single sheet wrapped around the container more than one time.

4. The label of claim 2, wherein the top layer and the bottom layer comprise two sheets, the bottom layer being applied directly to the container and the top layer being applied on top of the bottom layer.

5. The label of claim 1, wherein each window cut-out includes on the first surface of the top layer a releasable adhesive adapted to releasably attach each window cut-out to the second surface of the bottom layer.

6. The label of claim 1, wherein the distinct user groups are identified by at least one of age and weight.

7. The label of claim 1, wherein the separate information sets include dosages.

8. The label of claim 1, wherein:
the further printed information identifying the distinct user group on the second surface of the top layer includes information identifying two or more distinct user subgroups; and
the printed information set appearing on the second surface of the bottom layer beneath the respective window cut-out includes two or more information subsets corresponding to and identifying a corresponding one of the distinct user subgroups.

9. The label of claim 8, wherein the further printed information identifying the two or more distinct user subgroups includes a printed range encompassing the two or more distinct user subgroups.

10. The label of claim 1, wherein each window cut-out is substantially rectangular, the window cut-out being openable by peeling the window cut-out away from the bottom layer starting on an edge opposite the attached edge.

11. A container including a label, the label comprising:
a bottom layer having a first surface and a second surface opposite the first surface, the first surface of the bottom layer including an adhesive adapted to attach the bottom layer to the container, the second surface of the bottom layer including at least two separate printed information sets, each printed information set being applicable to a respective distinct user group; and
a top layer having a first surface and a second surface opposite the first surface, the top layer being attached to the bottom layer, the top layer including at least two window cut-outs, each window cut-out including a flap and an attached edge, each flap being pivotal about the attached edge to expose the second surface of the bottom layer beneath the flap, each flap aligned with the corresponding printed information set on the second surface of the bottom layer, each window cut-out including on the second surface further printed information identifying the distinct user group corresponding to the printed information set appearing on the second surface of the bottom layer beneath the respective window cut-out.

12. The container of claim 11, wherein the top layer is attached to the bottom layer by a further adhesive arranged one of:
on the first surface of the top layer in an area separate from the window cut-outs; and
on the second surface of the bottom layer in an area separate from the information sets corresponding to the window cut-outs.

13. The container of claim 12, wherein the top layer and the bottom layer comprise a single sheet wrapped around the container more than one time.

14. The container of claim 12, wherein the top layer and the bottom layer comprise two sheets, the bottom layer being applied directly to the container and the top layer being applied on top of the bottom layer.

15. The container of claim 11, wherein each window cut-out includes on the first surface of the top layer a releasable adhesive adapted to releasably attach each window cut-out to the second surface of the bottom layer.

16. The container of claim 11, wherein:
the distinct user groups are identified by at least one of age and weight; and
the separate information sets include dosages.

17. A method of attaching a label to a container, the method comprising:
applying a top layer of the label to a bottom layer of the label, the top layer and bottom layer each having a first surface and a second surface opposite the first surface, the first surface of the top layer being attached to the second surface of the bottom layer, the second surface of the bottom layer including at least two separate printed information sets, each printed information set being applicable to a respective distinct user group, the top layer including at least two window cut-outs, each window cut-out including a flap and an attached edge, each flap being pivotal about the attached edge to expose the second surface of the bottom layer beneath the flap, each flap aligned with a corresponding one of the printed information sets on the second surface of the bottom layer, each window cut-out including on the second surface of the top layer further printed information identifying the distinct user group corresponding to the printed information set appearing on the bottom layer frontside beneath the respective window cut-out; and
attaching the first surface of the bottom layer to the container using an adhesive.

18. The method of claim 17, wherein the top layer is attached to the bottom layer by one of:
a further adhesive arranged on the first surface of the top layer in an area separate from the window cut-outs; and
a further adhesive arranged on the second surface of the bottom layer in an area separate from the printed information sets corresponding to the window cut-outs.

19. The method of claim 17, wherein the operation of attaching the first surface of the bottom layer to the container using an adhesive is performed after the operation of applying the top layer of the label to the bottom layer of the label.

20. A method of attaching a label to a container, the method comprising:
applying a first part of the label to the container, the first part of the label forming a bottom layer having a first surface and a second surface opposite the first surface, the first surface of the bottom layer including an adhesive adapted to attach the bottom layer to the container, the second surface of the bottom layer including at least two separate printed information sets, each printed information set being applicable to a respective distinct user group; and
applying a second part of the label to the container, the first and second parts of the layer comprising a single sheet, the second part of the label being wrapped around the container continuously after applying the first part of the label, the second part of the label forming a top layer of the label, the top layer having a first surface and a second surface opposite the first surface, the top layer including at least two window cut-outs, each window cut-out including a flap and an attached edge, each flap being pivotal about the attached edge to expose the second surface of the bottom layer beneath the flap, each flap aligned with a corresponding printed information set on the second surface of the bottom layer, each window cut-out including on the second surface of the top layer further printed information identifying the distinct user group corresponding to the printed information set appearing on the second surface of the bottom layer beneath the respective window cut-out.
